(19) United States
(12) Patent Application Publication
(10) Pub. No.: US 2026/0180647 A1
(43) Pub. Date: Jun. 25, 2026

(54) TECHNIQUES FOR DOPPLER FREQUENCY BASED CHANNEL STATE INFORMATION PREDICTION

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Taesang YOO, San Diego, CA (US)

(21) Appl. No.: 18/988,478

(22) Filed: Dec. 19, 2024

(51) Int. Cl. H04B 7/06; H04B 17/364; H04B 17/391

(52) U.S. Cl. CPC H04B 7/0626; H04B 17/364; H04B 17/3913

(57) ABSTRACT

Methods, systems, and devices for wireless communications are described. Techniques provide for Doppler frequency based channel state information (CSI) prediction. In some examples, a user equipment (UE) may receive, from a network entity, a first control signal that indicates one or more channel measurement resources. The UE may measure one or more channel characteristics associated with the one or more channel measurement resources to obtain one or more measurements. The UE may transmit, to the network entity, a CSI report. The CSI report may include, based on a Doppler frequency associated with the one or more channel measurement resources, the one or more measurements or one or more predicted measurements of the one or more channel characteristics. The one or more predicted measurements of the one or more channel characteristics may be based on the one or more measurements of the one or more channel characteristics.

### FIELD OF TECHNOLOGY

The following relates to wireless communications, including techniques for Doppler frequency based channel state information prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, a first control signal that indicates one or more channel measurement resources, measuring one or more channel characteristics associated with the one or more channel measurement resources to obtain one or more measurements of the one or more channel characteristics, and transmitting, to the network entity, a channel state information (CSI) report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics.

A UE for wireless communications is described. The UE may include one or more memories storing processor executable code, and one or more processors coupled with the one or more memories. The one or more processors may individually or collectively be operable to execute the code to cause the UE to receive, from a network entity, a first control signal that indicates one or more channel measurement resources, measure one or more channel characteristics associated with the one or more channel measurement resources to obtain one or more measurements of the one or more channel characteristics, and transmit, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics.

Another UE for wireless communications is described. The UE may include means for receiving, from a network entity, a first control signal that indicates one or more channel measurement resources, means for measuring one or more channel characteristics associated with the one or more channel measurement resources to obtain one or more measurements of the one or more channel characteristics, and means for transmitting, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics.

A non-transitory computer-readable medium storing code for wireless communications is described. The code may include instructions executable by one or more processors to receive, from a network entity, a first control signal that indicates one or more channel measurement resources, measure one or more channel characteristics associated with the one or more channel measurement resources to obtain one or more measurements of the one or more channel characteristics, and transmit, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics.

In some examples of the method, user equipment (UEs), and non-transitory computer-readable medium described herein, transmitting the CSI report may include operations, features, means, or instructions for including, in the CSI report, the one or more measurements of the one or more channel characteristics or the one or more predicted measurements of the one or more channel characteristics based on a comparison of the Doppler frequency with a threshold, where the one or more measurements of the one or more channel characteristics may be included in the CSI report when the Doppler frequency may be less than the threshold, and where the one or more predicted measurements of the one or more channel characteristics may be included in the CSI report when the Doppler frequency may be greater than the threshold.

Some examples of the method, user equipment (UEs), and non-transitory computer-readable medium described herein may further include operations, features, means, or instructions for receiving, from the network entity prior to transmission of the CSI report, the threshold associated with the Doppler frequency.

In some examples of the method, user equipment (UEs), and non-transitory computer-readable medium described herein, the threshold may be associated with a frequency band.

In some examples of the method, user equipment (UEs), and non-transitory computer-readable medium described herein, transmitting the CSI report may include operations, features, means, or instructions for including, in the CSI report, the one or more measurements of the one or more channel characteristics or the one or more predicted measurements of the one or more channel characteristics based on a prediction window associated with the CSI report and a channel coherency time associated with the Doppler frequency; where the prediction window may be based on a report time at which the CSI report may be transmitted.

In some examples of the method, user equipment (UEs), and non-transitory computer-readable medium described herein, including, in the CSI report, the one or more measurements of the one or more channel characteristics or the one or more predicted measurements of the one or more channel characteristics may include operations, features, means, or instructions for including the one or more measurements of the one or more channel characteristics in the CSI report based on the report time being less than the channel coherency time or including the one or more predicted measurements of the one or more channel characteristics in the CSI report based on the report time being greater than the channel coherency time.

Some examples of the method, user equipment (UEs), and non-transitory computer-readable medium described herein may further include operations, features, means, or instructions for generating the one or more predicted measurements of the one or more channel characteristics based on the Doppler frequency.

Some examples of the method, user equipment (UEs), and non-transitory computer-readable medium described herein may further include operations, features, means, or instructions for generating the one or more predicted measurements of the one or more channel characteristics based on the Doppler frequency and a prediction window, where the prediction window may be based on a report time at which the CSI report may be transmitted.

Some examples of the method, user equipment (UEs), and non-transitory computer-readable medium described herein may further include operations, features, means, or instructions for transmitting, to the network entity, a Doppler report that indicates the Doppler frequency associated with the one or more channel measurement resources and receiving, from the network entity based on the Doppler report, a second control signal that indicates a configuration associated with the CSI report, where the configuration indicates that the CSI report includes the one or more channel measurement resources or the one or more predicted measurements of the one or more channel characteristics.

Some examples of the method, user equipment (UEs), and non-transitory computer-readable medium described herein may further include operations, features, means, or instructions for receiving, from the network entity prior to transmitting the CSI report, a second control signal that indicates a configuration associated with the CSI report, where the configuration indicates that the CSI report includes the one or more channel measurement resources or the one or more predicted measurements of the one or more channel characteristics based on the Doppler frequency.

In some examples of the method, user equipment (UEs), and non-transitory computer-readable medium described herein, the CSI report includes a validity duration associated with the one or more channel measurement resources or the one or more predicted measurements of the one or more channel characteristics.

In some examples of the method, user equipment (UEs), and non-transitory computer-readable medium described herein, the one or more predicted measurements of the one or more channel characteristics may be associated with a group of resources based on the Doppler frequency.

In some examples of the method, user equipment (UEs), and non-transitory computer-readable medium described herein, the one or more predicted measurements of the one or more channel characteristics may be associated with a group of time domain resources based on a channel coherency time associated with the Doppler frequency and the group of time domain resources may be less than the channel coherency time.

Some examples of the method, user equipment (UEs), and non-transitory computer-readable medium described herein may further include operations, features, means, or instructions for transmitting, to the network entity, a second control signal that indicates a prediction recommendation based on the Doppler frequency and computational resources of the UE, where the prediction recommendation indicates whether the UE recommends a determination of predicted measurements of the one or more channel characteristics associate with future resources.

A method for wireless communications by a UE is described. The method may include receiving, from a network entity, a first control signal that indicates one or more channel measurement resources, measuring one or more channel characteristics associated with the one or more channel measurement resources to obtain one or more measurements of the one or more channel characteristics, and transmitting, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics.

A UE for wireless communications is described. The UE may include one or more memories storing processor executable code, and one or more processors coupled with the one or more memories. The one or more processors may individually or collectively be operable to execute the code to cause the UE to receive, from a network entity, a first control signal that indicates one or more channel measurement resources, measure one or more channel characteristics associated with the one or more channel measurement resources to obtain one or more measurements of the one or more channel characteristics, and transmit, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics.

Another UE for wireless communications is described. The UE may include means for receiving, from a network entity, a first control signal that indicates one or more channel measurement resources, means for measuring one or more channel characteristics associated with the one or more channel measurement resources to obtain one or more measurements of the one or more channel characteristics, and means for transmitting, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics.

A non-transitory computer-readable medium storing code for wireless communications is described. The code may include instructions executable by one or more processors to receive, from a network entity, a first control signal that indicates one or more channel measurement resources, measure one or more channel characteristics associated with the one or more channel measurement resources to obtain one or more measurements of the one or more channel characteristics, and transmit, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics.

Some examples of the method, user equipment (UEs), and non-transitory computer-readable medium described herein may further include operations, features, means, or instructions for receiving, from the network entity prior to transmitting the CSI report, a second control signal that indicates a configuration associated with the CSI report, where the configuration indicates that the CSI report includes the validity duration.

Some examples of the method, user equipment (UEs), and non-transitory computer-readable medium described herein may further include operations, features, means, or instructions for generating one or more predicted measurements of the one or more channel characteristics based on the one or more measurements of the one or more channel characteristics, where the one or more channel characteristics may be based on the one or more predicted measurements of the one or more channel characteristics.

In some examples of the method, user equipment (UEs), and non-transitory computer-readable medium described herein, the validity duration indicates a start time and an end time associated with the one or more predicted measurements of the one or more channel characteristics.

In some examples of the method, user equipment (UEs), and non-transitory computer-readable medium described herein, the validity duration indicates a start time and an end time associated with a subset of the one or more predicted measurements of the one or more channel characteristics.

Some examples of the method, user equipment (UEs), and non-transitory computer-readable medium described herein may further include operations, features, means, or instructions for receiving, from the network entity based at least on the validity duration, a second control signal that indicates a CSI prediction periodicity.

Some examples of the method, user equipment (UEs), and non-transitory computer-readable medium described herein may further include operations, features, means, or instructions for receiving, from the network entity based at least on the validity duration, a second control signal that indicates a reference signal periodicity.

In some examples of the method, user equipment (UEs), and non-transitory computer-readable medium described herein, the validity duration may be based on a confidence associated with one or more predicted measurements of the one or more channel characteristics.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for Doppler frequency based channel state information (CSI) prediction in accordance with one or more aspects of the present disclosure.

FIG. 2 shows an example of a wireless communications system that supports techniques for Doppler frequency based CSI prediction in accordance with one or more aspects of the present disclosure.

FIG. 3 shows an example of a process flow that supports techniques for Doppler frequency based CSI prediction in accordance with one or more aspects of the present disclosure.

FIG. 4 shows an example of a process flow that supports techniques for Doppler frequency based CSI prediction in accordance with one or more aspects of the present disclosure.

FIGS. 5 and 6 show block diagrams of devices that support techniques for Doppler frequency based CSI prediction in accordance with one or more aspects of the present disclosure.

FIG. 7 shows a block diagram of a communications manager that supports techniques for Doppler frequency based CSI prediction in accordance with one or more aspects of the present disclosure.

FIG. 8 shows a diagram of a system including a device that supports techniques for Doppler frequency based CSI prediction in accordance with one or more aspects of the present disclosure.

FIGS. 9 and 10 show block diagrams of devices that support techniques for Doppler frequency based CSI prediction in accordance with one or more aspects of the present disclosure.

FIG. 11 shows a block diagram of a communications manager that supports techniques for Doppler frequency based CSI prediction in accordance with one or more aspects of the present disclosure.

FIG. 12 shows a diagram of a system including a device that supports techniques for Doppler frequency based CSI prediction in accordance with one or more aspects of the present disclosure.

FIGS. 13 through 15 show flowcharts illustrating methods that support techniques for Doppler frequency based CSI prediction in accordance with one or more aspects of the present disclosure.

### DETAILED DESCRIPTION

In some wireless communications systems, a network entity may schedule a user equipment (UE) to measure and report channel characteristics. For example, the network may schedule the UE with channel measurement resources, and the UE may utilize the channel measurement resources to measure channel characteristics of the communication channel. The UE may transmit, to the network entity, channel state information (CSI) reports including the measured channel characteristics. The network entity may utilize the CSI reports in scheduling the UE on future resources. In some cases, CSI reports with the measured channel characteristics may be out of date at the time of the future scheduling by the network entity. In some examples, the UE may use an artificial intelligence (AI) model or a machine learning (ML) model and previously measured channel characteristics to predict channel characteristics on future channel measurement resources. However, the AI or ML model prediction may use significant computation resources to generate the predicted channel characteristics. The UE may transmit, to the network entity, CSI reports including the predicted channel characteristics.

In some cases, the communication channel may have high Doppler frequency. In the high Doppler scenarios, the measured channel characteristics may expire quickly resulting in a high mis-match between the reported CSI and actual channel characteristics at the time of scheduling by the network entity. The mis-match between the reported CSI and the actual channel characteristics may degrade the communication performance. In some cases, the communication channel may have low Doppler frequency. In the low Doppler scenarios, the measured channel characteristics may not expire quickly resulting in a lower mis-match between the reported CSI and actual channel characteristics at the time of scheduling than high Doppler scenarios. In low Doppler scenarios, using the AI or ML model to predict channel characteristics may be an inefficient use of computational resources.

Techniques for Doppler frequency based CSI prediction may be employed. In some examples, the UE may switch between reporting CSI predictions and CSI measurements based on a Doppler frequency associated with the communication channel to address the performance or computational complexity trade-offs. In some examples, the UE may associate a validity duration (or freshness duration or expiry duration) with the CSI report and after the validity duration, the reported CSI may be considered invalid. For example, the UE may receive, from the network entity, a control signal that indicates a channel measurement resource. The UE may measure a channel characteristic associated with the channel measurement resource. The UE may transmit, to the network entity, a CSI report. In some examples, the CSI report may include a channel characteristic and a validity duration associated with the channel characteristic, and the validity duration may be based on a Doppler frequency associated with the channel measurement resource. In some examples, the CSI report may include, based at least in part on the Doppler frequency, the measured channel characteristics or a predicted channel characteristic. The term “measured channel characteristics” refers to measurements of channel characteristics, and the term “predicted channel characteristics” refers to predicted measurements of channel characteristics.

Aspects of the disclosure are initially described in the context of wireless communications systems. Aspects of the disclosure are further illustrated by and described with reference to process flows, apparatus diagrams, system diagrams, and flowcharts that relate to techniques for Doppler frequency based CSI prediction.

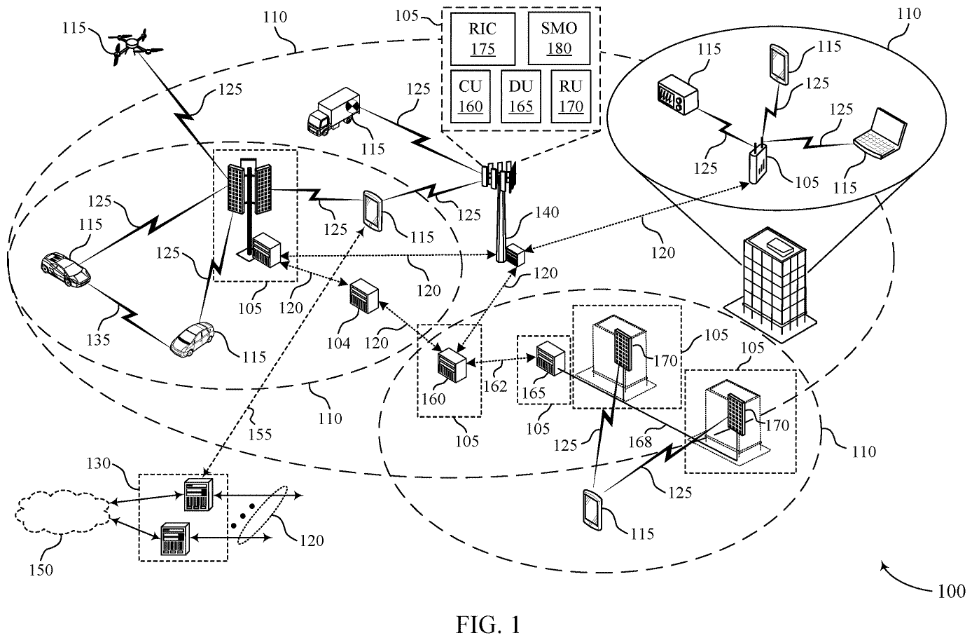

FIG. 1 shows an example of a wireless communications system 100 that supports techniques for Doppler frequency based CSI prediction in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for Doppler frequency based CSI prediction as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some wireless communications systems, the network entity 105 may schedule the UE 115 to measure and report channel characteristics. For example, the network 105 may schedule the UE 115 with channel measurement resources, and the UE 115 may utilize the channel measurement resources to measure channel characteristics of the communication channel. The UE 115 may transmit, to the network entity 105, CSI reports including the measured channel characteristics (e.g., measurements of channel characteristics). The network entity 105 may utilize the CSI reports in scheduling the UE 115 on future resources. In some cases, CSI reports with the measured channel characteristics may be out of date at the time of scheduling by the network entity 105. In some examples, the UE 115 may use an AI model or a ML model and previously measured channel characteristics to predict channel characteristics on future channel measurement resources. The AI or ML model prediction may use significant computation resources to generate the predicted channel characteristics. The UE 115 may transmit, to the network entity 105, CSI reports including the predicted channel characteristics.

In some cases, the communication channel may have high Doppler frequency. In the high Doppler scenarios, the measured channel characteristics may expire quickly resulting in a high mis-match between the reported CSI and actual channel characteristics at the time of scheduling by the network entity 105. The mis-match between the reported CSI and the actual channel characteristics may degrade the communication performance. In some cases, the communication channel may have low Doppler frequency. In the low Doppler scenarios, the measured channel characteristics may not expire quickly resulting in a lower mis-match between the reported CSI and actual channel characteristics at the time of scheduling than high Doppler scenarios. In low Doppler scenarios, using the AI or ML model to predict channel characteristics may be an inefficient use of computational resources.

Techniques for Doppler frequency based CSI prediction may be employed. In some examples, the UE 115 may switch between reporting CSI predictions and CSI measurements based on a Doppler frequency associated with the communication channel to address the performance or computational complexity trade-offs. In some examples, the UE 115 may associate a validity duration (or freshness duration or expiry duration) with the CSI report and after the validity duration, the reported CSI may be considered invalid. For example, the UE 115 may receive, from the network entity 105, a control signal that indicates a channel measurement resource. The UE 115 may measure a measured channel characteristic associated with the channel measurement resource. The UE 115 may transmit, to the network entity 105, a CSI report. In some examples, the CSI report may include a channel characteristic and a validity duration associated with the channel characteristic, and the validity duration may be based on a Doppler frequency associated with the channel measurement resource. In some examples, the CSI report may include, based at least in part on the Doppler frequency, the measured channel characteristics or a predicted channel characteristic.

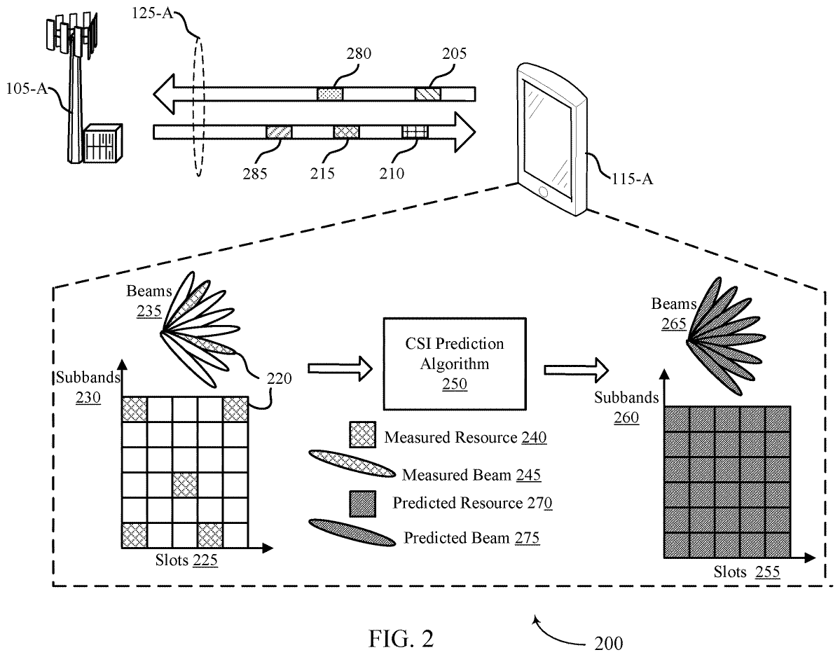

FIG. 2 shows an example of a wireless communications system 200 that supports techniques for Doppler frequency based CSI prediction in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples, the UE 115-a may communicate with the network entity 105-a using a communication link 125-a. The communication link 125-a may be an example of a 6th generation (6G), a NR or LTE link between the UE 115-a and the network entity. The communication link 125-a may include a bi-directional link that enable both uplink and downlink communications. For example, the UE 115-b may transmit uplink signals 205 (e.g., uplink transmissions), such as uplink control signals or uplink data signals, to the network entity 105-a using the communication link 125-a and the network entity 105-a may transmit downlink signals 210 (e.g., downlink transmissions), such as downlink control signals or downlink data signals, to the UE 115-b using the communication link 125-a.

In some examples, the network entity 105-a may schedule the UE 115-a to measure channel characteristics and report the measured channel characteristics. The UE 115-a may transmit, to the network entity 105-a, CSI reports including the measured channel characteristics. The network entity may utilize the CSI reports in scheduling the UE on future resources. In some cases, CSI reports with the measured channel characteristics may be out of date at the time of scheduling by the network entity 105-a. In some examples, the UE 115-a may use CSI prediction to address the mis-match between the measured CSI and the actual use of the CSI in scheduling the UE 115-a.

For cases without CSI prediction, the UE 115-a may sample and hold CSI reporting. For example, the network entity 105-a may schedule the UE 115-a with channel measurement resources, such as resources for receiving a CSI reference signal (CSI-RS) and synchronization signal blocks (SSB), to measure channel characteristics or channel conditions. The UE 115-a may utilize the channel measurement resources to measure the channel characteristics or CSI, such as a channel quality indicator (CQI), a precoding matrix indicator (PMI), a rank indicator (RI), a layer one reference signal received power (L1 RSPR) and other quantities that represent channel conditions. The UE 115-a may transmit, to the network entity 105-a, a CSI report including the measured channel characteristics. The network entity 105-a may utilize the CSI report to schedule the UE 115-a on future resources, including using the CSI report for resource selection and for determining a modulation and coding scheme (MCS), a rank, precoding, or a combination thereof. Sample and hold of CSI may introduces a delay between the channel measurement resources used to estimate CSI and the actual use of the CSI in scheduling the UE 115-a. The delay may create a mismatch that affects the system performance because the measured CSI may be outdated or expired at the time of scheduling the UE 115-a.

In some cases, the UE 115-a or the network entity 105-a may perform CSI prediction. By observing the channel variation patterns on previous channel measurement resources, the UE 115-a or the network entity 105-a may predict the channel characteristics or the CSI on future channel measurement resources. To account for the different non-idealities in the CSI prediction, an AI model or a ML model may be used to predict the CSI on the future channel measurement resources. CSI prediction may address the mis-match challenge between the CSI measurements and the actual use of the CSI measurement in scheduling the UE 115-a which in turn may enhance system performance.

In CSI prediction, CSI measurements on a set of previous channel measurement resources may be used as an input to a CSI prediction algorithm to predict the CSI on a set of future channel measurement resources. The set of channel measurement resources and the set of prediction resource may vary in time (e.g., slots), space (e.g., beams), frequency (e.g., sub-bands), or a combination thereof.

In some examples, the UE 115-a may receive, from the network entity 105-a, a control signal 215 that indicates channel measurement resources 220. The channel measurement resources may vary in time (e.g., slots 225), frequency (subbands 230), space (beams 235), or a combination thereof. The UE 115-a may measure channel characteristics associated with the channel measurement resources 220 (e.g., measured resource 240, measured beam 245). The UE 115-a may generate predicted channel characteristics or predicted CSI using a CSI prediction algorithm 250. In some cases, the input to the CSI prediction algorithm 250 may be sparce measurements of channel characteristics on a subset of slots, sub-bands and beams (e.g., measured resource 240, measured beam 245). The CSI prediction algorithm 250 may be a deep neural network (e.g., recurrent neural network (RNN), convolutional neural network (CNN), transformer), a classical ML model (e.g., support vector machine (SVM), random forest model, k-nearest neighbors (KNN) algorithm), autoregressive approach, minimum mean square error (MMSE) predictor approach. The output of the CSI prediction algorithm 250 may be predicted channel characteristics or predicted CSI on future channel measurement resources, on a subset of future channel measurement resources, or on future slots (e.g., slots 255), future subbands (e.g., subbands 260), future beams (e.g., future beams 265), or a combination thereof. For example, the output of the CSI prediction algorithm 250 may be predicted characteristics on the future measurement resources (e.g., predicted resource 270, predicted beam 275). The UE 115-a may transmit, to the network entity 105-a, a CSI report 280. In some cases, the CSI report 280 may include the measured channel characteristics or measured CSI. In some cases, the CSI report 280 may include the predicted channel characteristics or predicted CSI. In some cases, the CSI report 280 may include both the measured channel characteristics and the predicted channel characteristics. The UE 115-a may report the predicted channel characteristics or the predicted CSI to help the network entity 105-a with future scheduling or future MCS decisions.

In some cases, the channel used for communications between the UE 115-a and the network entity 105-a may be associated with a high Doppler frequency or a low channel coherence time. Doppler frequency refers to a frequency shift of incoming electromagnetic waves caused by the motion of a transmitting device and a receiving device. For example, the high Doppler frequency may occur when the UE 115-a is moving at a high velocity. The channel coherency time may be a time for a wireless channel to change significantly. In high Doppler scenarios, the measured CSI may age or may expire quickly (e.g., the measured CSI may not be accurate after a duration). The rapidly aging CSI may lead to a high mis-match between the reported measured CSI and the actual use of the CSI in scheduling the UE 115-a. This high CSI mis-match may degrade the communication system performance. In high Doppler conditions, predicting the CSI may reduce the mis-match and enhance the overall system performance. In high Doppler scenarios, the UE 115-a may be configured to predict the CSI on future resources to enhance performance.

In some cases, the communication channel may have low Doppler frequency or high channel coherence time. For example, the low Doppler frequency may occur when the UE 115-a is moving at a low velocity or when the UE 115-a is stationary. In low Doppler scenarios, the measured CSI may age or may expire slowly, and there is lower mis-match between the reported measured CSI and the actual use of the CSI in scheduling the UE 115-a. In low Doppler scenarios, the UE 115-a may refrain from predicting the CSI to reduce the computing complexity at the UE 115-a, and the UE 115-a may report the measured CSI. The network entity 105-a may use the measured CSI in scheduling the UE 115-a. The UE 115-a may be equipped with limited computational resources that may be used for multiple AI or ML use cases. In low Doppler cases, the UE 115-a may save the computational resources for other AI or ML use-cases (e.g., ML based positioning). In low Doppler scenarios, using the AI or ML model to predict channel characteristics may be an inefficient use of computational resources.

In some examples, techniques for Doppler frequency based CSI prediction may be employed. In some examples, the UE 115-a may switch between reporting CSI predictions and CSI measurements based on a Doppler frequency associated with the communication channel to address the performance or computational complexity trade-offs. In some examples, the UE 115-a may associate a validity duration (or freshness duration or expiry duration) with the CSI report and after the validity duration, the reported CSI may be considered invalid.

In some cases, the UE 115-a may receive, from the network entity 105-a, a control signal 285 that indicates a threshold associated with the Doppler frequency. The UE 115-a may be configured with the threshold on the Doppler frequency, and the UE 115-a may report the predicted CSI to the network entity 105-a based on the threshold associated with the Doppler frequency. For example, if the Doppler frequency of the communication channel is below the preconfigured threshold, the UE 115-a may report the measured CSI; if the Doppler frequency of the communication channel is greater than or equal to the threshold, the UE 115-a may predict the CSI and may report the predicted CSI. In some cases, the UE 115-a may be configured with a threshold associated with the UE speed, and if the UE speed is below the preconfigured threshold, the UE 115-a may report the measured CSI or if the UE speed is greater than or equal to the threshold, the UE 115-a may predict the CSI and may report the predicted CSI. In some examples, the UE 115-a may be configured with a threshold associated with a channel coherency time, and if the channel coherency time is greater the preconfigured threshold, the UE 115-a may report the measured CSI or if the channel coherency time is less than the threshold, the UE 115-a may predict the CSI and may report the predicted CSI.

In some examples, the UE 115-a may implement different CSI prediction configurations for different frequency bands based on the Doppler frequency. The channel coherence time is inversely proportional to the carrier frequency. Higher carrier frequencies may have higher Doppler compared to lower frequencies. For example, FR2 may experience higher Doppler compared to FR1. Doppler frequency may be represented as

$${f}_{d} = \frac{v}{c} {f}_{c}$$

where f_{d} is the Doppler frequency, f_{c} is the carrier frequency, V is the UE speed, and C is the speed of light. The UE 115-a may be configured with different Doppler thresholds for different frequency bands to switch between the CSI prediction and CSI measurement reporting. Thresholds associated with the Doppler frequency may be configured based on configurations received from the network entity 105-a or the thresholds may be predefined. In some cases, the network entity 105-a may update the Doppler thresholds based on the scheduling algorithm of the network entity 105-a.

In some cases, the UE 115-a may be configured with a threshold associated with the channel coherency time, and the coherency time threshold may be based on a prediction window. The UE 115-a may be configured to switch between CSI measurement and CSI prediction reporting based on the relationship between the prediction window and the channel coherence time. For example, if the channel coherence time is 200 milliseconds (ms) and the UE 115-a is configured to report the CSI at a time 100 ms in the future, the UE 115-a may report the measured CSI because the report time at which the CSI report is to be transmitted to the network entity 105-a is less than the channel coherency time. For example, if the coherence time is 100 ms and the UE 115-a is configured to report the CSI at a time 200 ms in the future, the UE 115-a may predict CSI and may report the predicted CSI because the report time at which the CSI report is to be transmitted to the network entity 105-a is greater than the channel coherency time (e.g., the measured CSI may be considered expired). In some cases, the threshold(s) associated with the channel coherency time may be defined based on a percentage of the channel coherence time (e.g., 50% or 90% coherence time). For example, if the channel coherence time is 200 milliseconds (ms), the threshold is 75% of the channel coherency time, and the UE 115-a is configured to report the CSI 100 ms in the future, the UE 115-a may report the measured CSI because the report time at which the CSI report is to be transmitted to the network entity 105-a is less than the threshold (e.g., 75% of the channel coherency time 75% of 200 ms or 150 ms).

In some examples, the CSI prediction algorithm 250 may be based on the Doppler conditions and the time window of the CSI prediction. In some cases, the UE 115-a may be configured to switch the CSI prediction algorithm 250 based on the Doppler conditions and time window for prediction. For example, the UE 115-a may receive, from the network entity 105-a, a control signal that indicates a CSI prediction algorithm associated with different levels of Doppler frequency. CSI prediction approaches may include auto-regressive prediction, MMSE prediction, neural-network based prediction, or other ML prediction algorithms. Higher Doppler conditions may use a more complex CSI prediction algorithm, while simpler prediction approaches may provide accurate CSI predictions in lower Doppler conditions. In some cases, the CSI prediction algorithm may be based on a report time at which the CSI report is to be transmitted. For example, predicted CSI to be transmitted a greater duration in the future may use a complex CSI prediction algorithm, while simpler prediction approaches may provide accurate CSI predictions in near future.

In some cases, the network entity 105-a may configure the UE 115-a to adaptively predict CSI and report the predicted CSI to the network entity 105-a or report the measured CSI to the network entity 105-a based on the Doppler conditions. For example, the UE 115-a may transmit, to the network entity 105-a, a control signal that indicates a Doppler report or the Doppler frequency associated with the channel measurement resources. In some cases, the network entity 105-a may measure the Doppler frequency or the channel coherency time. For example, the UE 115-a may transmit, to the network entity 105-a, a sounding reference signal (SRS), and the network entity 105-a may measure the Doppler frequency or channel coherency time based on the SRS. Based on the Doppler frequency or the channel coherency time, the network entity 105-a may configure the UE 115-a to either report the measured CSI or the predicted CSI. For example, the network entity 105-a may transmit, to the UE 115-a, a control signal that configures whether the UE 115-a transmits the measured CSI or the predicted CSI. The UE 115-a may report the measured CSI or predicted CSI following the configuration provided by the network entity 105-a. In some examples, the network entity 105-a may configure the UE 115-a to autonomously report the measured CSI or the predicted CSI based on Doppler conditions. For example, the UE 115-a may receive, from the network entity 105-a, a control signal that indicates a configuration associated with the CSI report, and the configuration may indicate that the CSI report includes the measured CSI or the predicted CSI based on the Doppler frequency. The UE 115-a, based on the configuration, may measure the Doppler frequency and may autonomously switch between reporting the measured CSI and the predicted CSI based on the measured Doppler frequency.

In some cases, the UE 115-a may indicate whether the CSI report includes measured CSI or predicted CSI. The UE 115-a may indicate the channel measurement resources (e.g., slots, beams, subbands) associated with the predicted CSI. In some cases, the UE 115-a may be configured to report a vector of CSI predictions on future channel measurement resources. The network entity 105-a may indicate the channel measurement resources over which the UE 115-a is to predict CSI.

In some examples, a freshness metric, an expiry time, or a validity duration may be associated with the CSI. The freshness metric, an expiry time, or a validity duration may be based on the Doppler frequency associated with the channel measurement resources. Based on the Doppler conditions (or channel coherence time or UE speed), the network entity 105-a may configure the UE 115-a to estimate and report the validity duration of a predicted CSI along with the CSI prediction. After the validity duration, the predicted CSI may be considered invalid. For example, the UE 115-a may receive, from the network entity 105-a, a control signal that indicates a configuration associated with the CSI report, and the configuration may indicate that the CSI report include the validity duration. In some cases, the UE 115-a may be configured to report a group of CSI predictions and associate an applicability duration (start and end time) for each CSI prediction. In a high Doppler environment, the CSI predictions may expire quickly; however, in a low Doppler environment, the CSI predictions may last for a longer duration. The UE 115-a may report the validity duration (or another freshness metric) for the CSI prediction to the network entity 105-a. Based on the validity duration or the freshness metric, the network entity 105-a may increase or decrease the CSI prediction periodicity at the UE 115-a or a reference signal periodicity that may be used as inputs to the CSI prediction model to ensure having an unexpired CSI prediction. In some examples, the validity expiry time may depend in part on a confidence (e.g., an accuracy value, such as a percentage) associated with the predicted CSI. For example, if the UE 115-a has a high confidence (e.g., an accuracy value above a threshold) in the predicted CSI, the UE 115-a may associate longer validity time for the predicted CSI. If the UE 115-a has a low confidence (e.g., an accuracy value below a threshold) in the predicted CSI, the UE 115-a may associate a shorter validity time in the predicted CSI.

In some cases, the UE 115-a may group channel measurement resources based on the Doppler conditions. For example, based on the Doppler conditions, the UE 115-a may associate a CSI prediction with a group of channel measurement resources. The predicted CSI may be associated with a group of time domain resources based on a channel coherency time associated with the Doppler frequency, where the group of time domain resources is less than the channel coherency time. For example, if the channel coherency time is greater than 20 slots, the UE 115-a may reported a predicted CSI for a group of 20 slots. If the channel coherence time is greater than 5 slots and less than 10 slots, the UE 115-a may report a predicted CSI for a group of 5 slots but may not report a predicted CSI for a group of ten slots. In some cases, the grouping of resources may be configured by the network entity 105-a.

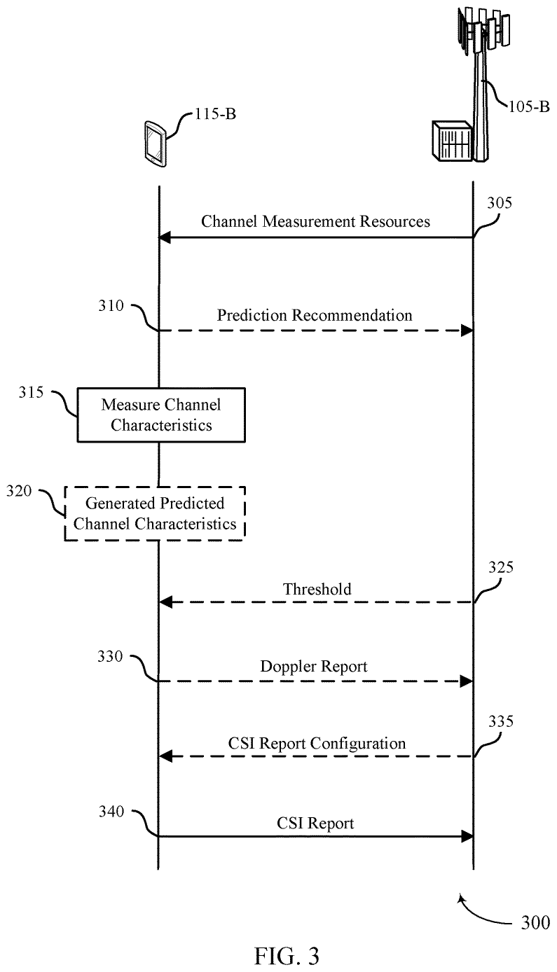

FIG. 3 shows an example of a process flow 300 that supports techniques for Doppler frequency based CSI prediction in accordance with one or more aspects of the present disclosure. The process flow 300 may implement or may be implemented by aspects of the wireless communications system 100 or the wireless communications system 200. For example, the process flow 300 may include a UE 115-b, which may be an example of a UE 115 as described herein. The process flow 300 may include a network entity 105-b, which may be an example of a network entity 105 as described herein. In the following description of the process flow 300, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 300, and other operations may be added to the process flow 300.

At 305, the UE 115-b may receive, from the network entity 105-b, a first control signal that indicates one or more channel measurement resources.

At 310, the UE 115-b may transmit, to the network entity 105-b, a second control signal that indicates a prediction recommendation based on a Doppler frequency associated with the one or more channel measurement resources and computational resources of the UE 115-b. The prediction recommendation may indicate whether the UE 115-b recommends a determination of predicted measurements of the one or more channel characteristics associate with future resources.

At 315, the UE 115-b may measure one or more channel characteristics associated with the one or more channel measurement resources to obtain one or more measurements of the one or more channel characteristics.

At 320, the UE 115-b may generate one or more predicted measurements of the one or more channel characteristics. The one or more predicted measurements of the one or more channel characteristics may be based on the one or more measurements of the one or more channel characteristics. In some cases, the one or more predicted measurements of the one or more channel characteristics may be based on the Doppler frequency. In some examples, the one or more predicted measurements of the one or more channel characteristics may be based on a prediction window, where the prediction window may be based on a report time at which the CSI report is to be transmitted. In some cases, the one or more predicted measurements of the one or more channel characteristics may be associated with a group of resources based at least in part on the Doppler frequency. In some examples, the one or more predicted measurements of the one or more channel characteristics may be associated with a group of time domain resources based on a channel coherency time associated with the Doppler frequency, where the group of time domain resources is less than the channel coherency time.

At 325, the UE 115-b may receive, from the network entity 105-b, a threshold associated with the Doppler frequency. In some cases, the threshold is associated with a frequency band.

At 330, the UE 115-b may transmit, to the network entity 105-b, a Doppler report that indicates the Doppler frequency associated with the one or more channel measurement resources.

At 335, the UE 115-b may receive, from the network entity 105-b based on the Doppler report, a second control signal that indicates a configuration associated with the CSI report, where the configuration indicates that the CSI report includes the one or more channel measurement resources or the one or more predicted measurements of the one or more channel characteristics. In some cases, the configuration may indicate that the CSI report includes the one or more channel measurement resources or the one or more predicted measurements of the one or more channel characteristics based on the Doppler frequency.

At 340, the UE 115-a may transmit, to the network entity 105-b, a CSI report. In some cases, the CSI report may include, based on the Doppler frequency associated with the one or more channel measurement resources, the one or more measured channel characteristics or one or more predicted measurements of the one or more channel characteristics. In some examples, the CSI report may include the one or more measurements of the one or more channel characteristics or the one or more predicted measurements of the one or more channel characteristics based on a comparison of the Doppler frequency with the threshold. The one or more measurements of the one or more channel characteristics may be included in the CSI report when the Doppler frequency is less than the threshold. The one or more predicted measurements of the one or more channel characteristics may be included in the CSI report when the Doppler frequency is greater than the threshold.

In some cases, the CSI report may include the one or more measured channel characteristics or the one or more predicted measurements of the one or more channel characteristics based on a prediction window associated with the CSI report and a channel coherency time associated with the Doppler frequency, where the prediction window may be based on a report time at which the CSI report is to be transmitted. In some examples, the one or more measurements of the one or more channel characteristics may be included the CSI report based on the report time being less than the channel coherency time or the one or more predicted measurements of the one or more channel characteristics may be included in the CSI report based on the report time being greater than the channel coherency time.

In some cases, the CSI report may include a validity duration associated with the one or more channel measurement resources or the one or more predicted measurements of the one or more channel characteristics.

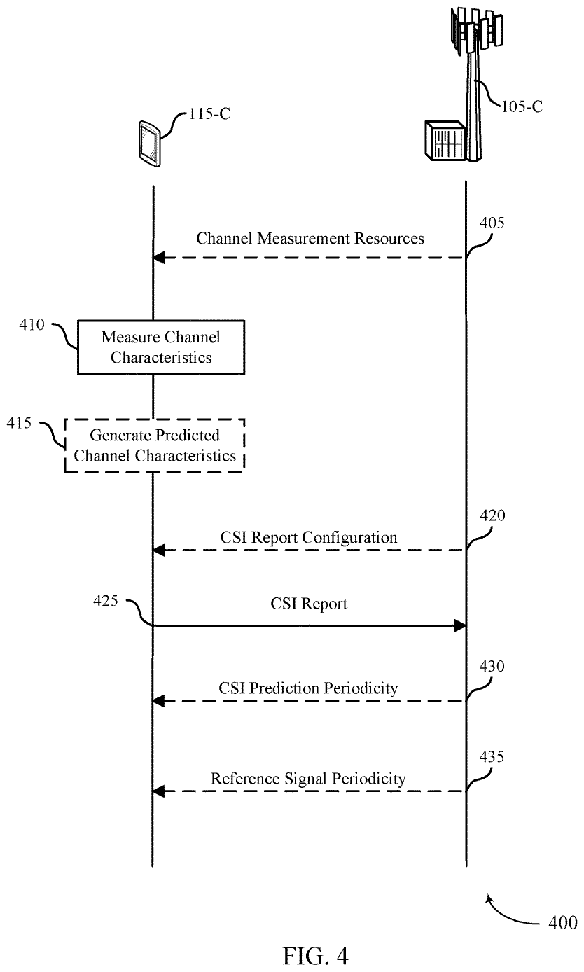

FIG. 4 shows an example of a process flow 400 that supports techniques for Doppler frequency based CSI prediction in accordance with one or more aspects of the present disclosure. The process flow 400 may implement or may be implemented by aspects of the wireless communications system 100 or the wireless communications system 200. For example, the process flow 400 may include a UE 115-c, which may be an example of a UE 115 as described herein. The process flow 400 may include a network entity 105-c, which may be an example of a network entity 105 as described herein. In the following description of the process flow 400, the operations between the network entity 105-c and the UE 115-c may be transmitted in a different order than the example order shown, or the operations performed by the network entity 105-c and the UE 115-c may be performed in different orders or at different times. Some operations may also be omitted from the process flow 400, and other operations may be added to the process flow 400.

At 405, the UE 115-c may receive, from the network entity 105-c, a first control signal that indicates one or more channel measurement resources.

At 410, the UE 115-c may measure one or more channel characteristics associated with the one or more channel measurement resources to obtain one or more measurements of the one or more channel characteristics.

At 415, the UE 115-c may generate one or more predicted measurements of the one or more channel characteristics. In some cases, the one or more predicted measurements of the one or more channel characteristics may be based on the Doppler frequency. The one or more predicted measurements of the one or more channel characteristics may be based on the one or more measurements of the one or more channel characteristics.

At 420, the UE 115-c may receive, from the network entity 105-b, a second control signal that indicates a configuration associated with the CSI report, where the configuration indicates that the CSI report includes validity duration.

At 425, the UE 115-c may transmit, to the network entity 105-c, a CSI report. In some cases, the CSI report may include one or more channel characteristics and a validity duration associated with the one or more channel characteristics. The validity duration may be based on a Doppler frequency associated with the one or more channel measurement resources. The one or more channel characteristics may be based at least in part on the one or more measurements of the one or more channel characteristics.

In some cases, the validity duration may indicate a start time and an end time associated with the one or more predicted measurements of the one or more channel characteristics. In some examples, the validity duration may indicate a start time and an end time associated with a subset of the one or more predicted measurements of the one or more channel characteristics. In some cases, the validity duration may be based on a confidence associated with one or more predicted measurements of the one or more channel characteristics. In some cases, the validity duration may indicate a start time and an end time associated with the one or more measurements of the one or more channel characteristics.

At 430, the UE 115-c may receive, from the network entity 105-b, a control signal that indicates a CSI prediction periodicity.

At 435, the UE 115-c may receive, from the network entity 105-b, a control signal that indicates a reference signal periodicity.

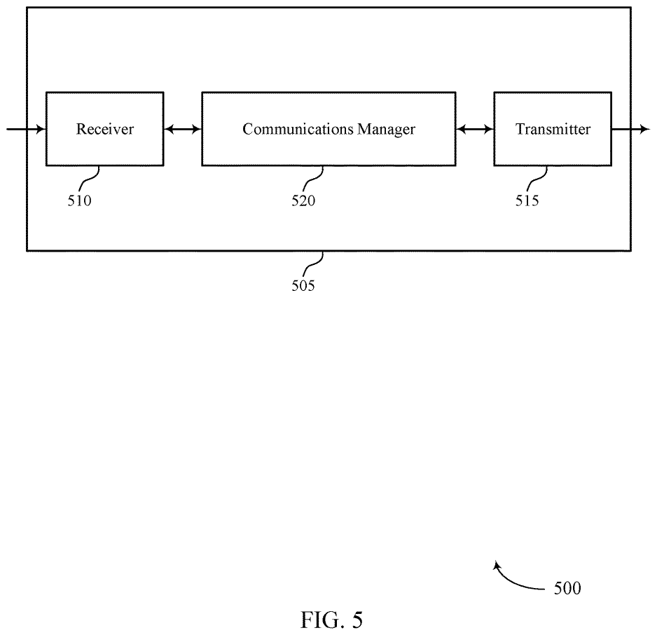

FIG. 5 shows a block diagram 500 of a device 505 that supports techniques for Doppler frequency based CSI prediction in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for Doppler frequency based CSI prediction). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for Doppler frequency based CSI prediction). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for Doppler frequency based CSI prediction as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a network entity, a first control signal that indicates one or more channel measurement resources. The communications manager 520 is capable of, configured to, or operable to support a means for measuring one or more channel characteristics associated with the one or more channel measurement resources to obtain one or more measurements of the one or more channel characteristics. The communications manager 520 is capable of, configured to, or operable to support a means for transmitting, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics.

Additionally, or alternatively, the communications manager 520 may support wireless communications in accordance with examples as disclosed herein. For example, the communications manager 520 is capable of, configured to, or operable to support a means for receiving, from a network entity, a first control signal that indicates one or more channel measurement resources. The communications manager 520 is capable of, configured to, or operable to support a means for measuring one or more channel characteristics associated with the one or more channel measurement resources to obtain one or more measurements of the one or more channel characteristics. The communications manager 520 is capable of, configured to, or operable to support a means for transmitting, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

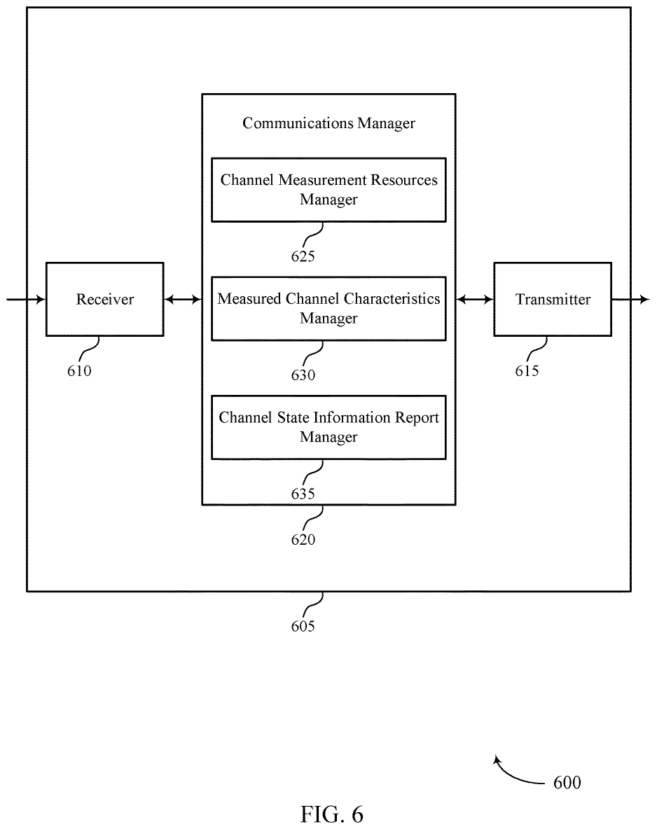

FIG. 6 shows a block diagram 600 of a device 605 that supports techniques for Doppler frequency based CSI prediction in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for Doppler frequency based CSI prediction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for Doppler frequency based CSI prediction). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for Doppler frequency based CSI prediction as described herein. For example, the communications manager 620 may include a channel measurement resources manager 625, a measured channel characteristics manager 630, a CSI report manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The channel measurement resources manager 625 is capable of, configured to, or operable to support a means for receiving, from a network entity, a first control signal that indicates one or more channel measurement resources. The measured channel characteristics manager 630 is capable of, configured to, or operable to support a means for measuring one or more channel characteristics associated with the one or more channel measurement resources to obtain one or more measurements of the one or more channel characteristics. The CSI report manager 635 is capable of, configured to, or operable to support a means for transmitting, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics.

Additionally, or alternatively, the communications manager 620 may support wireless communications in accordance with examples as disclosed herein. The channel measurement resources manager 625 is capable of, configured to, or operable to support a means for receiving, from a network entity, a first control signal that indicates one or more channel measurement resources. The measured channel characteristics manager 630 is capable of, configured to, or operable to support a means for measuring one or more channel characteristics associated with the one or more channel measurement resources to obtain one or more measurements of the one or more channel characteristics. The CSI report manager 635 is capable of, configured to, or operable to support a means for transmitting, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics.

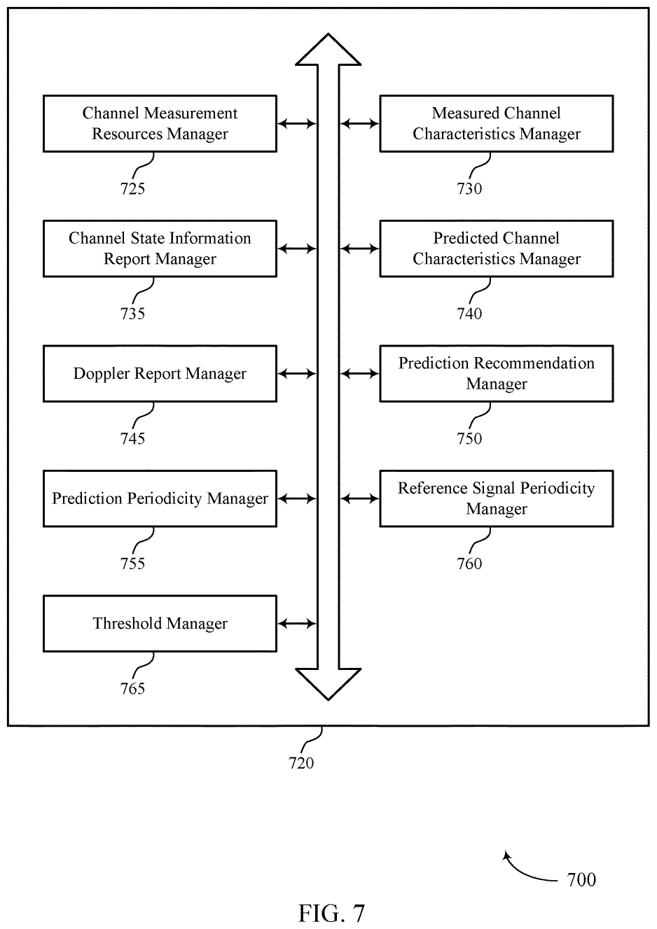

FIG. 7 shows a block diagram 700 of a communications manager 720 that supports techniques for Doppler frequency based CSI prediction in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for Doppler frequency based CSI prediction as described herein. For example, the communications manager 720 may include a channel measurement resources manager 725, a measured channel characteristics manager 730, a CSI report manager 735, a predicted measurements of the one or more channel characteristics manager 740, a Doppler report manager 745, a prediction recommendation manager 750, a prediction periodicity manager 755, a reference signal periodicity manager 760, a threshold manager 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The channel measurement resources manager 725 is capable of, configured to, or operable to support a means for receiving, from a network entity, a first control signal that indicates one or more channel measurement resources. The measured channel characteristics manager 730 is capable of, configured to, or operable to support a means for measuring one or more channel characteristics associated with the one or more channel measurement resources to obtain one or more measurements of the one or more channel characteristics. The CSI report manager 735 is capable of, configured to, or operable to support a means for transmitting, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics.

In some examples, to support transmitting the CSI report, the CSI report manager 735 is capable of, configured to, or operable to support a means for including, in the CSI report, the one or more measurements of the one or more channel characteristics or the one or more predicted measurements of the one or more channel characteristics based on a comparison of the Doppler frequency with a threshold, where the one or more measurements of the one or more channel characteristics are included in the CSI report when the Doppler frequency is less than the threshold, and where the one or more predicted measurements of the one or more channel characteristics are included in the CSI report when the Doppler frequency is greater than the threshold.

In some examples, the threshold manager 765 is capable of, configured to, or operable to support a means for receiving, from the network entity prior to transmission of the CSI report, the threshold associated with the Doppler frequency.

In some examples, the threshold is associated with a frequency band.

In some examples, to support transmitting the CSI report, the CSI report manager 735 is capable of, configured to, or operable to support a means for including, in the CSI report, the one or more measurements of the one or more channel characteristics or the one or more predicted measurements of the one or more channel characteristics based on a prediction window associated with the CSI report and a channel coherency time associated with the Doppler frequency; where the prediction window is based on a report time at which the CSI report is to be transmitted.

In some examples, to support including, in the CSI report, the one or more measurements of the one or more channel characteristics or the one or more predicted measurements of the one or more channel characteristics, the CSI report manager 735 is capable of, configured to, or operable to support a means for including the one or more measurements of the one or more channel characteristics in the CSI report based on the report time being less than the channel coherency time or including the one or more predicted measurements of the one or more channel characteristics in the CSI report based on the report time being greater than the channel coherency time.

In some examples, the predicted channel characteristics manager 740 is capable of, configured to, or operable to support a means for generating the one or more predicted measurements of the one or more channel characteristics based on the Doppler frequency.

In some examples, the predicted channel characteristics manager 740 is capable of, configured to, or operable to support a means for generating the one or more predicted measurements of the one or more channel characteristics based on the Doppler frequency and a prediction window, where the prediction window is based on a report time at which the CSI report is to be transmitted.

In some examples, the Doppler report manager 745 is capable of, configured to, or operable to support a means for transmitting, to the network entity, a Doppler report that indicates the Doppler frequency associated with the one or more channel measurement resources. In some examples, the CSI report manager 735 is capable of, configured to, or operable to support a means for receiving, from the network entity based on the Doppler report, a second control signal that indicates a configuration associated with the CSI report, where the configuration indicates that the CSI report includes the one or more channel measurement resources or the one or more predicted measurements of the one or more channel characteristics.

In some examples, the CSI report manager 735 is capable of, configured to, or operable to support a means for receiving, from the network entity prior to transmitting the CSI report, a second control signal that indicates a configuration associated with the CSI report, where the configuration indicates that the CSI report includes the one or more channel measurement resources or the one or more predicted measurements of the one or more channel characteristics based on the Doppler frequency.

In some examples, the CSI report includes a validity duration associated with the one or more channel measurement resources or the one or more predicted measurements of the one or more channel characteristics.

In some examples, the one or more predicted measurements of the one or more channel characteristics are associated with a group of resources based on the Doppler frequency.

In some examples, the one or more predicted measurements of the one or more channel characteristics are associated with a group of time domain resources based on a channel coherency time associated with the Doppler frequency. In some examples, the group of time domain resources is less than the channel coherency time.

In some examples, the prediction recommendation manager 750 is capable of, configured to, or operable to support a means for transmitting, to the network entity, a second control signal that indicates a prediction recommendation based on the Doppler frequency and computational resources of the UE, where the prediction recommendation indicates whether the UE recommends a determination of predicted measurements of the one or more channel characteristics associate with future resources.

Additionally, or alternatively, the communications manager 720 may support wireless communications in accordance with examples as disclosed herein. In some examples, the channel measurement resources manager 725 is capable of, configured to, or operable to support a means for receiving, from a network entity, a first control signal that indicates one or more channel measurement resources. In some examples, the measured channel characteristics manager 730 is capable of, configured to, or operable to support a means for measuring one or more channel characteristics associated with the one or more channel measurement resources to obtain one or more measurements of the one or more channel characteristics. In some examples, the CSI report manager 735 is capable of, configured to, or operable to support a means for transmitting, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics.

In some examples, the CSI report manager 735 is capable of, configured to, or operable to support a means for receiving, from the network entity prior to transmitting the CSI report, a second control signal that indicates a configuration associated with the CSI report, where the configuration indicates that the CSI report includes the validity duration.

In some examples, the predicted channel characteristics manager 740 is capable of, configured to, or operable to support a means for generating one or more predicted measurements of the one or more channel characteristics based on the one or more measurements of the one or more channel characteristics, where the one or more channel characteristics are based on the one or more predicted measurements of the one or more channel characteristics.

In some examples, the validity duration indicates a start time and an end time associated with the one or more predicted measurements of the one or more channel characteristics.

In some examples, the validity duration indicates a start time and an end time associated with a subset of the one or more predicted measurements of the one or more channel characteristics.

In some examples, the prediction periodicity manager 755 is capable of, configured to, or operable to support a means for receiving, from the network entity based at least on the validity duration, a second control signal that indicates a CSI prediction periodicity.

In some examples, the reference signal periodicity manager 760 is capable of, configured to, or operable to support a means for receiving, from the network entity based at least on the validity duration, a second control signal that indicates a reference signal periodicity.

In some examples, the validity duration is based on a confidence associated with one or more predicted measurements of the one or more channel characteristics.

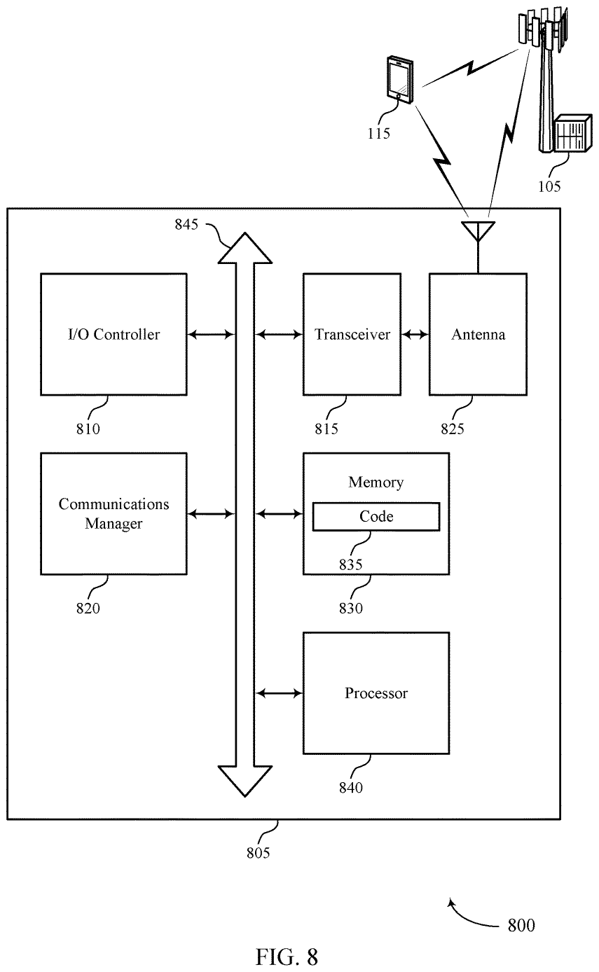

FIG. 8 shows a diagram of a system 800 including a device 805 that supports techniques for Doppler frequency based CSI prediction in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for Doppler frequency based CSI prediction). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, from a network entity, a first control signal that indicates one or more channel measurement resources. The communications manager 820 is capable of, configured to, or operable to support a means for measuring one or more channel characteristics associated with the one or more channel measurement resources to obtain one or more measurements of the one or more channel characteristics. The communications manager 820 is capable of, configured to, or operable to support a means for transmitting, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics.

Additionally, or alternatively, the communications manager 820 may support wireless communications in accordance with examples as disclosed herein. For example, the communications manager 820 is capable of, configured to, or operable to support a means for receiving, from a network entity, a first control signal that indicates one or more channel measurement resources. The communications manager 820 is capable of, configured to, or operable to support a means for measuring one or more channel characteristics associated with the one or more channel measurement resources to obtain one or more measurements of the one or more channel characteristics. The communications manager 820 is capable of, configured to, or operable to support a means for transmitting, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for Doppler frequency based CSI prediction as described herein, or the at least one processor 840 and the at least one memory 830 may be otherwise configured to, individually or collectively, perform or support such operations.

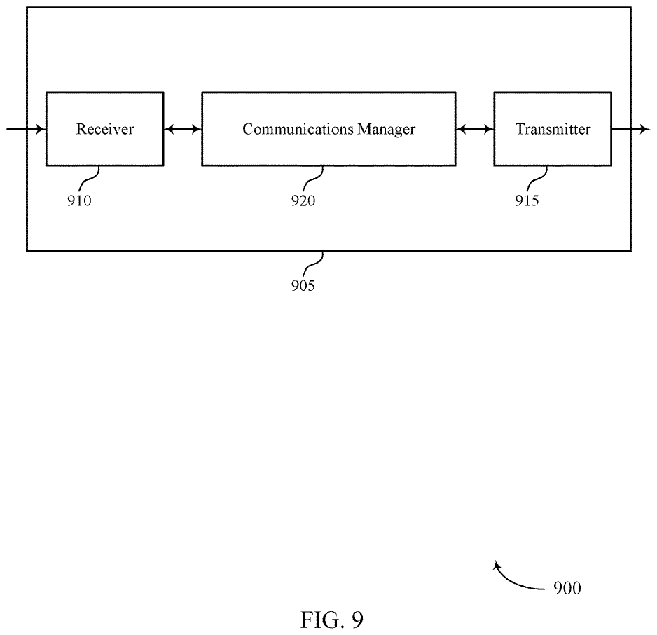

FIG. 9 shows a block diagram 900 of a device 905 that supports techniques for Doppler frequency based CSI prediction in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for Doppler frequency based CSI prediction as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, to a UE, a first control signal that indicates one or more channel measurement resources. The communications manager 920 is capable of, configured to, or operable to support a means for obtaining, from the UE, a CSI report, where the CSI report includes, based on a Doppler frequency associated with the one or more channel measurement resources, one or more measurements of the one or more channel characteristics or one or more predicted measurements of the one or more channel characteristics; where the one or more predicted measurements of the one or more channel characteristics are based on the one or more measurements of the one or more channel characteristics.

Additionally, or alternatively, the communications manager 920 may support wireless communications in accordance with examples as disclosed herein. For example, the communications manager 920 is capable of, configured to, or operable to support a means for outputting, to a UE, a first control signal that indicates one or more channel measurement resources. The communications manager 920 is capable of, configured to, or operable to support a means for obtaining, from the UE, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on one or more measurements of the one or more channel characteristics.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

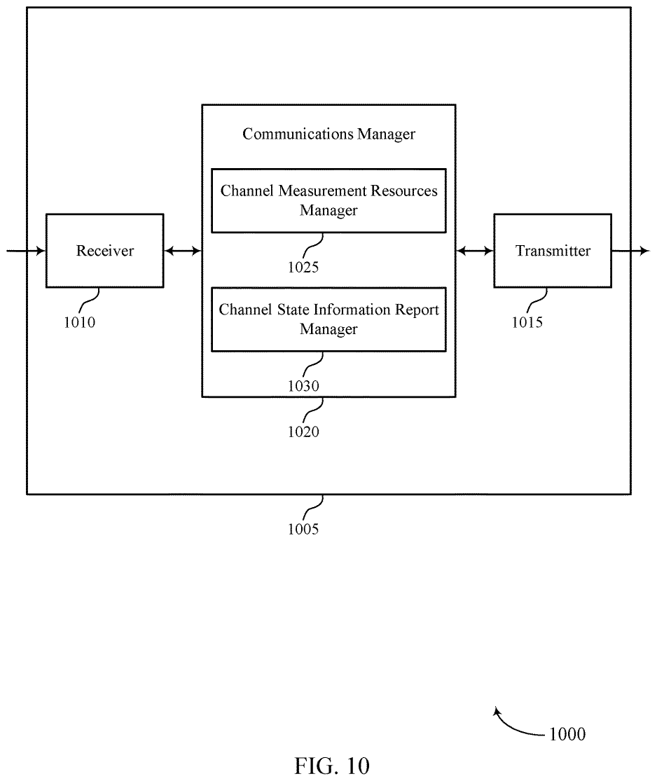

FIG. 10 shows a block diagram 1000 of a device 1005 that supports techniques for Doppler frequency based CSI prediction in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for Doppler frequency based CSI prediction as described herein. For example, the communications manager 1020 may include a channel measurement resources manager 1025 a CSI report manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The channel measurement resources manager 1025 is capable of, configured to, or operable to support a means for outputting, to a UE, a first control signal that indicates one or more channel measurement resources. The CSI report manager 1030 is capable of, configured to, or operable to support a means for obtaining, from the UE, a CSI report, where the CSI report includes, based on a Doppler frequency associated with the one or more channel measurement resources, one or more measurements of the one or more channel characteristics or one or more predicted measurements of the one or more channel characteristics; where the one or more predicted measurements of the one or more channel characteristics are based on the one or more measurements of the one or more channel characteristics.

Additionally, or alternatively, the communications manager 1020 may support wireless communications in accordance with examples as disclosed herein. The channel measurement resources manager 1025 is capable of, configured to, or operable to support a means for outputting, to a UE, a first control signal that indicates one or more channel measurement resources. The CSI report manager 1030 is capable of, configured to, or operable to support a means for obtaining, from the UE, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on one or more measurements of the one or more channel characteristics.

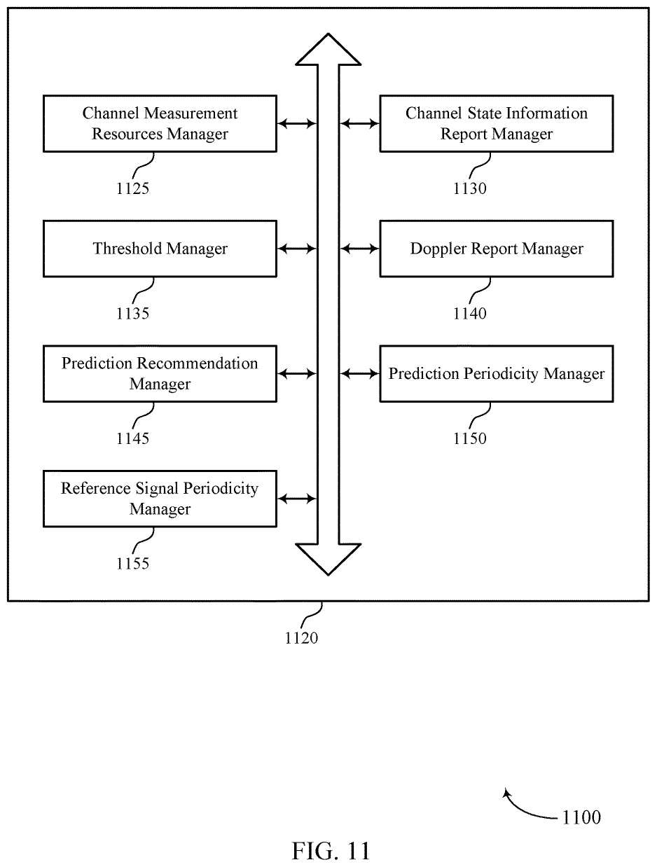

FIG. 11 shows a block diagram 1100 of a communications manager 1120 that supports techniques for Doppler frequency based CSI prediction in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for Doppler frequency based CSI prediction as described herein. For example, the communications manager 1120 may include a channel measurement resources manager 1125, a CSI report manager 1130, a threshold manager 1135, a Doppler report manager 1140, a prediction recommendation manager 1145, a prediction periodicity manager 1150, a reference signal periodicity manager 1155, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The channel measurement resources manager 1125 is capable of, configured to, or operable to support a means for outputting, to a UE, a first control signal that indicates one or more channel measurement resources. The CSI report manager 1130 is capable of, configured to, or operable to support a means for obtaining, from the UE, a CSI report, where the CSI report includes, based on a Doppler frequency associated with the one or more channel measurement resources, one or more measurements of the one or more channel characteristics or one or more predicted measurements of the one or more channel characteristics; where the one or more predicted measurements of the one or more channel characteristics are based on the one or more measurements of the one or more channel characteristics.

In some examples, the threshold manager 1135 is capable of, configured to, or operable to support a means for outputting, to the UE prior to obtaining the CSI report, a threshold associated with the Doppler frequency.

In some examples, the CSI report includes the one or more measurements of the one or more channel characteristics or the one or more predicted measurements of the one or more channel characteristics based on a comparison of the Doppler frequency with the threshold. In some examples, the one or more measurements of the one or more channel characteristics are included in the CSI report when the Doppler frequency is less than the threshold. In some examples, the one or more predicted measurements of the one or more channel characteristics are included in the CSI report when the Doppler frequency is greater than the threshold.

In some examples, the threshold is associated with a frequency band.

In some examples, the CSI report includes the one or more measurements of the one or more channel characteristics or the one or more predicted measurements of the one or more channel characteristics based on a prediction window associated with the CSI report and a channel coherency time associated with the Doppler frequency. In some examples, the prediction window is based on a report time at which the CSI report is to be transmitted.

In some examples, the CSI report includes the one or more measurements of the one or more channel characteristics based on the report time being less than the channel coherency time or the CSI report includes the one or more predicted measurements of the one or more channel characteristics based on the report time being greater than the channel coherency time.

In some examples, the Doppler report manager 1140 is capable of, configured to, or operable to support a means for obtaining, from the UE, a Doppler report that indicates the Doppler frequency associated with the one or more channel measurement resources. In some examples, the CSI report manager 1130 is capable of, configured to, or operable to support a means for outputting, to the network entity based on the Doppler report, a second control signal that indicates a configuration associated with the CSI report, where the configuration indicates that the CSI report includes the one or more channel measurement resources or the one or more predicted measurements of the one or more channel characteristics.

In some examples, the CSI report manager 1130 is capable of, configured to, or operable to support a means for outputting, to the UE prior to obtaining the CSI report, a second control signal that indicates a configuration associated with the CSI report, where the configuration indicates that the CSI report includes the one or more channel measurement resources or the one or more predicted measurements of the one or more channel characteristics based on the Doppler frequency.

In some examples, the CSI report includes a validity duration associated with the one or more channel measurement resources or the one or more predicted measurements of the one or more channel characteristics.

In some examples, the one or more predicted measurements of the one or more channel characteristics are associated with a group of resources based on the Doppler frequency.

In some examples, the one or more predicted measurements of the one or more channel characteristics are associated with a group of time domain resources based on a channel coherency time associated with the Doppler frequency. In some examples, the group of time domain resources is less than the channel coherency time.

In some examples, the prediction recommendation manager 1145 is capable of, configured to, or operable to support a means for obtaining, from the UE, a second control signal that indicates a prediction recommendation based on the Doppler frequency and computational resources of the UE, where the prediction recommendation indicates whether the UE recommends a determination of predicted measurements of the one or more channel characteristics associate with future resources.

Additionally, or alternatively, the communications manager 1120 may support wireless communications in accordance with examples as disclosed herein. In some examples, the channel measurement resources manager 1125 is capable of, configured to, or operable to support a means for outputting, to a UE, a first control signal that indicates one or more channel measurement resources. In some examples, the CSI report manager 1130 is capable of, configured to, or operable to support a means for obtaining, from the UE, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on one or more measurements of the one or more channel characteristics.

In some examples, the CSI report manager 1130 is capable of, configured to, or operable to support a means for outputting, to the UE prior to obtaining the CSI report, a second control signal that indicates a configuration associated with the CSI report, where the configuration indicates that the CSI report includes the validity duration.

In some examples, the validity duration indicates a start time and an end time associated with one or more predicted measurements of the one or more channel characteristics.

In some examples, the prediction periodicity manager 1150 is capable of, configured to, or operable to support a means for outputting, to the UE based at least on the validity duration, a second control signal that indicates a CSI prediction periodicity.

In some examples, the reference signal periodicity manager 1155 is capable of, configured to, or operable to support a means for outputting, to the UE based at least on the validity duration, a second control signal that indicates a reference signal periodicity.

In some examples, the validity duration is based on a confidence associated with one or more predicted measurements of the one or more channel characteristics.

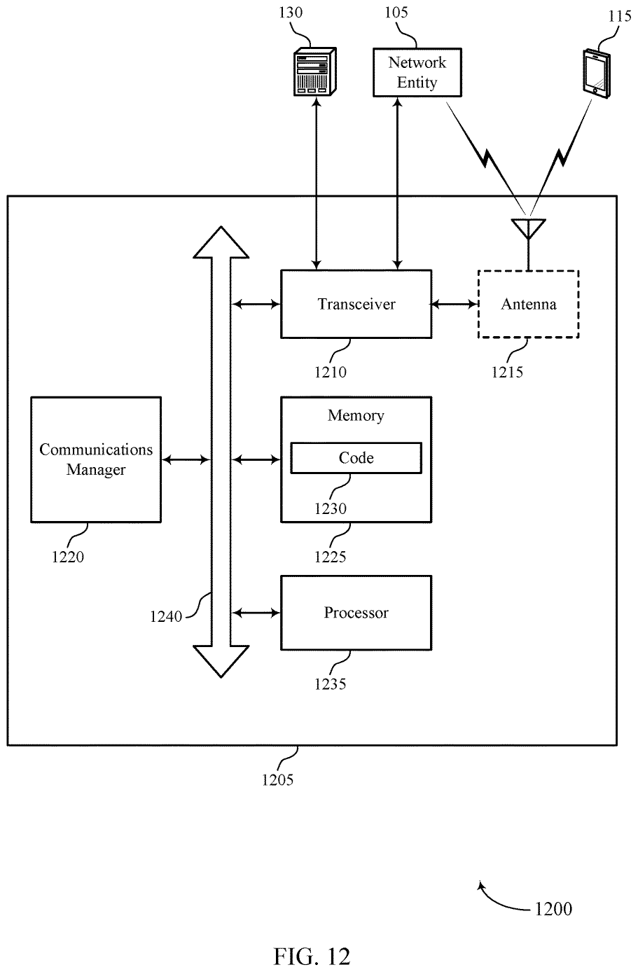

FIG. 12 shows a diagram of a system 1200 including a device 1205 that supports techniques for Doppler frequency based CSI prediction in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for Doppler frequency based CSI prediction). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, to a UE, a first control signal that indicates one or more channel measurement resources. The communications manager 1220 is capable of, configured to, or operable to support a means for obtaining, from the UE, a CSI report, where the CSI report includes, based on a Doppler frequency associated with the one or more channel measurement resources, one or more measurements of the one or more channel characteristics or one or more predicted measurements of the one or more channel characteristics; where the one or more predicted measurements of the one or more channel characteristics are based on the one or more measurements of the one or more channel characteristics.

Additionally, or alternatively, the communications manager 1220 may support wireless communications in accordance with examples as disclosed herein. For example, the communications manager 1220 is capable of, configured to, or operable to support a means for outputting, to a UE, a first control signal that indicates one or more channel measurement resources. The communications manager 1220 is capable of, configured to, or operable to support a means for obtaining, from the UE, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on one or more measurements of the one or more channel characteristics.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for Doppler frequency based CSI prediction as described herein, or the at least one processor 1235 and the at least one memory 1225 may be otherwise configured to, individually or collectively, perform or support such operations.

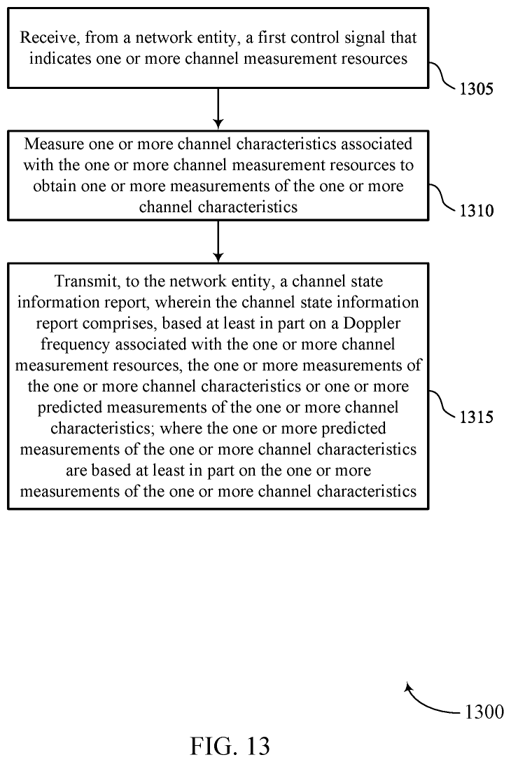

FIG. 13 shows a flowchart illustrating a method 1300 that supports techniques for Doppler frequency based CSI prediction in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, a first control signal that indicates one or more channel measurement resources. The operations of 1305 may be performed in accordance with examples as disclosed herein. In some examples, aspects of the operations of 1305 may be performed by a channel measurement resources manager 725 as described with reference to FIG. 7.

At 1310, the method may include measuring one or more channel characteristics associated with the one or more channel measurement resources to obtain one or more measurements of the one or more channel characteristics. The operations of 1310 may be performed in accordance with examples as disclosed herein. In some examples, aspects of the operations of 1310 may be performed by a measured channel characteristics manager 730 as described with reference to FIG. 7.

At 1315, the method may include transmitting, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics. The operations of 1315 may be performed in accordance with examples as disclosed herein. In some examples, aspects of the operations of 1315 may be performed by a CSI report manager 735 as described with reference to FIG. 7.

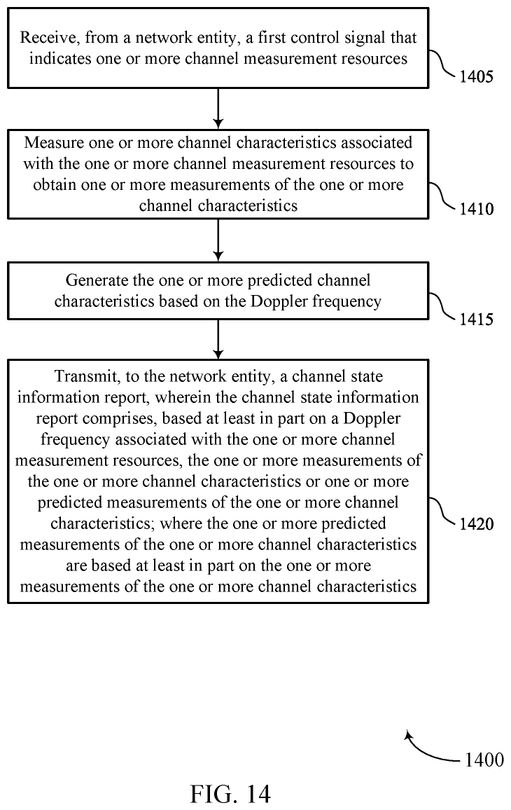

FIG. 14 shows a flowchart illustrating a method 1400 that supports techniques for Doppler frequency based CSI prediction in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a first control signal that indicates one or more channel measurement resources. The operations of 1405 may be performed in accordance with examples as disclosed herein. In some examples, aspects of the operations of 1405 may be performed by a channel measurement resources manager 725 as described with reference to FIG. 7.

At 1410, the method may include measuring one or more channel characteristics associated with the one or more channel measurement resources to obtain one or more measurements of the one or more channel characteristics. The operations of 1410 may be performed in accordance with examples as disclosed herein. In some examples, aspects of the operations of 1410 may be performed by a measured channel characteristics manager 730 as described with reference to FIG. 7.

At 1415, the method may include generating the one or more predicted measurements of the one or more channel characteristics based on the Doppler frequency. The operations of 1415 may be performed in accordance with examples as disclosed herein. In some examples, aspects of the operations of 1415 may be performed by a predicted channel characteristics manager 740 as described with reference to FIG. 7.

At 1420, the method may include transmitting, to the network entity, a CSI report, where the CSI report includes, based on a Doppler frequency associated with the one or more channel measurement resources, the one or more measurements of the one or more channel characteristics or one or more predicted measurements of the one or more channel characteristics; where the one or more predicted measurements of the one or more channel characteristics are based on the one or more measurements of the one or more channel characteristics. The operations of 1420 may be performed in accordance with examples as disclosed herein. In some examples, aspects of the operations of 1420 may be performed by a CSI report manager 735 as described with reference to FIG. 7.

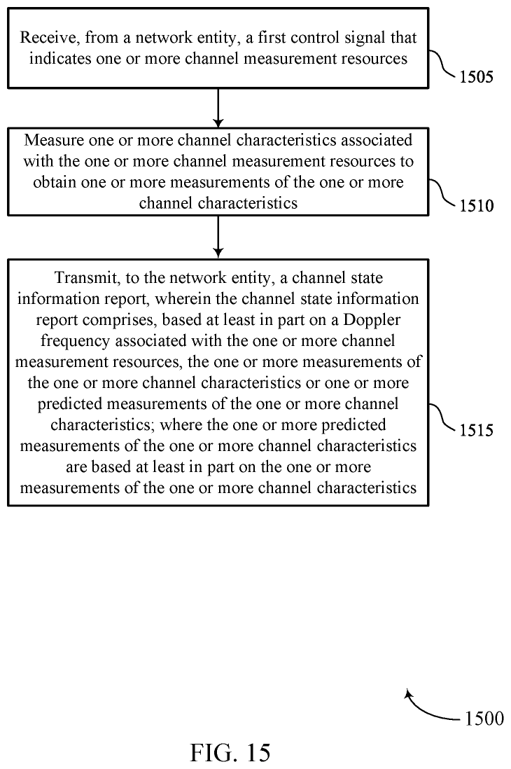

FIG. 15 shows a flowchart illustrating a method 1500 that supports techniques for Doppler frequency based CSI prediction in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a first control signal that indicates one or more channel measurement resources. The operations of 1505 may be performed in accordance with examples as disclosed herein. In some examples, aspects of the operations of 1505 may be performed by a channel measurement resources manager 725 as described with reference to FIG. 7.

At 1510, the method may include measuring one or more channel characteristics associated with the one or more channel measurement resources to obtain one or more measurements of the one or more channel characteristics. The operations of 1510 may be performed in accordance with examples as disclosed herein. In some examples, aspects of the operations of 1510 may be performed by a measured channel characteristics manager 730 as described with reference to FIG. 7.

At 1515, the method may include transmitting, to the network entity, a CSI report, where the CSI report includes one or more channel characteristics and a validity duration associated with the one or more channel characteristics, where the validity duration is based on a Doppler frequency associated with the one or more channel measurement resources, where the one or more channel characteristics are based on the one or more measurements of the one or more channel characteristics. The operations of 1515 may be performed in accordance with examples as disclosed herein. In some examples, aspects of the operations of 1515 may be performed by a CSI report manager 735 as described with reference to FIG. 7.

The following provides an overview of aspects of the present disclosure:
Aspect 1: A method for wireless communications by a UE, comprising: receiving, from a network entity, a first control signal that indicates one or more channel measurement resources; measuring one or more channel characteristics associated with the one or more channel measurement resources to obtain one or more measurements of the one or more channel characteristics; and transmitting, to the network entity, a CSI report, wherein the CSI report comprises, based at least in part on a Doppler frequency associated with the one or more channel measurement resources, the one or more measurements of the one or more channel characteristics or one or more predicted measurements of the one or more channel characteristics; wherein the one or more predicted measurements of the one or more channel characteristics are based at least in part on the one or more measurements of the one or more channel characteristics.
Aspect 2: The method of aspect 1, wherein transmitting the CSI report comprises: including, in the CSI report, the one or more measurements of the one or more channel characteristics or the one or more predicted measurements of the one or more channel characteristics based at least in part on a comparison of the Doppler frequency with a threshold, wherein the one or more measurements of the one or more channel characteristics are included in the CSI report when the Doppler frequency is less than the threshold, and wherein the one or more predicted measurements of the one or more channel characteristics are included in the CSI report when the Doppler frequency is greater than the threshold.
Aspect 3: The method of aspect 2, further comprising: receiving, from the network entity prior to transmission of the CSI report, the threshold associated with the Doppler frequency.
Aspect 4: The method of any of aspects 2 through 3, wherein the threshold is associated with a frequency band.
Aspect 5: The method of aspect 1, wherein transmitting the CSI report comprises: including, in the CSI report, the one or more measurements of the one or more channel characteristics or the one or more predicted measurements of the one or more channel characteristics based at least in part on a prediction window associated with the CSI report and a channel coherency time associated with the Doppler frequency; wherein the prediction window is based at least in part on a report time at which the CSI report is to be transmitted.
Aspect 6: The method of aspect 5, wherein including, in the CSI report, the one or more measurements of the one or more channel characteristics or the one or more predicted measurements of the one or more channel characteristics comprises: including the one or more measurements of the one or more channel characteristics in the CSI report based at least in part on the report time being less than the channel coherency time or including the one or more predicted measurements of the one or more channel characteristics in the CSI report based at least in part on the report time being greater than the channel coherency time.
Aspect 7: The method of any of aspects 1 through 6, further comprising: generating the one or more predicted measurements of the one or more channel characteristics based at least in part on the Doppler frequency.
Aspect 8: The method of aspect 1, further comprising: generating the one or more predicted measurements of the one or more channel characteristics based at least in part on the Doppler frequency and a prediction window, wherein the prediction window is based at least in part on a report time at which the CSI report is to be transmitted.
Aspect 9: The method of aspect 1, further comprising: transmitting, to the network entity, a Doppler report that indicates the Doppler frequency associated with the one or more channel measurement resources; and receiving, from the network entity based at least in part on the Doppler report, a second control signal that indicates a configuration associated with the CSI report, wherein the configuration indicates that the CSI report comprises the one or more channel measurement resources or the one or more predicted measurements of the one or more channel characteristics.
Aspect 10: The method of aspect 1, further comprising: receiving, from the network entity prior to transmitting the CSI report, a second control signal that indicates a configuration associated with the CSI report, wherein the configuration indicates that the CSI report comprises the one or more channel measurement resources or the one or more predicted measurements of the one or more channel characteristics based at least in part on the Doppler frequency.
Aspect 11: The method of aspect 1, wherein the CSI report comprises a validity duration associated with the one or more channel measurement resources or the one or more predicted measurements of the one or more channel characteristics.
Aspect 12: The method of aspect 1, wherein the one or more predicted measurements of the one or more channel characteristics are associated with a group of resources based at least in part on the Doppler frequency.
Aspect 13: The method of aspect 1, wherein the one or more predicted measurements of the one or more channel characteristics are associated with a group of time domain resources based at least in part on a channel coherency time associated with the Doppler frequency, the group of time domain resources is less than the channel coherency time.
Aspect 14: The method of aspect 1, further comprising: transmitting, to the network entity, a second control signal that indicates a prediction recommendation based at least in part on the Doppler frequency and computational resources of the UE, wherein the prediction recommendation indicates whether the UE recommends a determination of predicted measurements of the one or more channel characteristics associate with future resources.
Aspect 15: A method for wireless communications by a UE, comprising: receiving, from a network entity, a first control signal that indicates one or more channel measurement resources; measuring one or more channel characteristics associated with the one or more channel measurement resources to obtain one or more measurements of the one or more channel characteristics; and transmitting, to the network entity, a CSI report, wherein the CSI report comprises one or more channel characteristics and a validity duration associated with the one or more channel characteristics, wherein the validity duration is based at least in part on a Doppler frequency associated with the one or more channel measurement resources, wherein the one or more channel characteristics are based at least in part on the one or more measurements of the one or more channel characteristics.
Aspect 16: The method of aspect 15, further comprising: receiving, from the network entity prior to transmitting the CSI report, a second control signal that indicates a configuration associated with the CSI report, wherein the configuration indicates that the CSI report comprises the validity duration.
Aspect 17: The method of any of aspects 15 through 16, further comprising: generating one or more predicted measurements of the one or more channel characteristics based at least in part on the one or more measurements of the one or more channel characteristics, wherein the one or more channel characteristics are based at least in part on the one or more predicted measurements of the one or more channel characteristics.
Aspect 18: The method of aspect 17, wherein the validity duration indicates a start time and an end time associated with the one or more predicted measurements of the one or more channel characteristics.
Aspect 19: The method of aspect 17, wherein the validity duration indicates a start time and an end time associated with a subset of the one or more predicted measurements of the one or more channel characteristics.
Aspect 20: The method of aspect 15, further comprising: receiving, from the network entity based at least on the validity duration, a second control signal that indicates a CSI prediction periodicity.
Aspect 21: The method of aspect 15, further comprising: receiving, from the network entity based at least on the validity duration, a second control signal that indicates a reference signal periodicity.
Aspect 22: The method of aspect 15, wherein the validity duration is based at least in part on a confidence associated with one or more predicted measurements of the one or more channel characteristics.
Aspect 23: A method for wireless communications by a network entity, comprising: outputting, to a UE, a first control signal that indicates one or more channel measurement resources; and obtaining, from the UE, a CSI report, wherein the CSI report comprises, based at least in part on a Doppler frequency associated with the one or more channel measurement resources, one or more measurements of the one or more channel characteristics or one or more predicted measurements of the one or more channel characteristics; wherein the one or more predicted measurements of the one or more channel characteristics are based at least in part on the one or more measurements of the one or more channel characteristics.
Aspect 24: The method of aspect 23, further comprising: outputting, to the UE prior to obtaining the CSI report, a threshold associated with the Doppler frequency.
Aspect 25: The method of aspect 24, wherein the CSI report comprises the one or more measurements of the one or more channel characteristics or the one or more predicted measurements of the one or more channel characteristics based at least in part on a comparison of the Doppler frequency with the threshold, the one or more measurements of the one or more channel characteristics are included in the CSI report when the Doppler frequency is less than the threshold, and the one or more predicted measurements of the one or more channel characteristics are included in the CSI report when the Doppler frequency is greater than the threshold.
Aspect 26: The method of any of aspects 24 through 25, wherein the threshold is associated with a frequency band.
Aspect 27: The method of aspect 23, wherein the CSI report comprises the one or more measurements of the one or more channel characteristics or the one or more predicted measurements of the one or more channel characteristics based at least in part on a prediction window associated with the CSI report and a channel coherency time associated with the Doppler frequency; the prediction window is based at least in part on a report time at which the CSI report is to be transmitted.
Aspect 28: The method of aspect 27, wherein the CSI report comprises the one or more measurements of the one or more channel characteristics based at least in part on the report time being less than the channel coherency time or the CSI report comprises the one or more predicted measurements of the one or more channel characteristics based at least in part on the report time being greater than the channel coherency time.
Aspect 29: The method of aspect 23, further comprising: obtaining, from the UE, a Doppler report that indicates the Doppler frequency associated with the one or more channel measurement resources; and outputting, to the network entity based at least in part on the Doppler report, a second control signal that indicates a configuration associated with the CSI report, wherein the configuration indicates that the CSI report comprises the one or more channel measurement resources or the one or more predicted measurements of the one or more channel characteristics.
Aspect 30: The method of aspect 23, further comprising: outputting, to the UE prior to obtaining the CSI report, a second control signal that indicates a configuration associated with the CSI report, wherein the configuration indicates that the CSI report comprises the one or more channel measurement resources or the one or more predicted measurements of the one or more channel characteristics based at least in part on the Doppler frequency.
Aspect 31: The method of aspect 23, wherein the CSI report comprises a validity duration associated with the one or more channel measurement resources or the one or more predicted measurements of the one or more channel characteristics.
Aspect 32: The method of any of aspects 23 through 31, wherein the one or more predicted measurements of the one or more channel characteristics are associated with a group of resources based at least in part on the Doppler frequency.
Aspect 33: The method of aspect 23, wherein the one or more predicted measurements of the one or more channel characteristics are associated with a group of time domain resources based at least in part on a channel coherency time associated with the Doppler frequency, the group of time domain resources is less than the channel coherency time.
Aspect 34: The method of aspect 23, further comprising: obtaining, from the UE, a second control signal that indicates a prediction recommendation based at least in part on the Doppler frequency and computational resources of the UE, wherein the prediction recommendation indicates whether the UE recommends a determination of predicted measurements of the one or more channel characteristics associate with future resources.
Aspect 35: A method for wireless communications by a network entity, comprising: outputting, to a UE, a first control signal that indicates one or more channel measurement resources; and obtaining, from the UE, a CSI report, wherein the CSI report comprises one or more channel characteristics and a validity duration associated with the one or more channel characteristics, wherein the validity duration is based at least in part on a Doppler frequency associated with the one or more channel measurement resources, wherein the one or more channel characteristics are based at least in part on one or more measurements of the one or more channel characteristics.
Aspect 36: The method of aspect 35, further comprising: outputting, to the UE prior to obtaining the CSI report, a second control signal that indicates a configuration associated with the CSI report, wherein the configuration indicates that the CSI report comprises the validity duration.
Aspect 37: The method of any of aspects 35 through 36, wherein the validity duration indicates a start time and an end time associated with one or more predicted measurements of the one or more channel characteristics.
Aspect 38: The method of any of aspects 35 through 37, further comprising: outputting, to the UE based at least on the validity duration, a second control signal that indicates a CSI prediction periodicity.
Aspect 39: The method of aspect 35, further comprising: outputting, to the UE based at least on the validity duration, a second control signal that indicates a reference signal periodicity.
Aspect 40: The method of aspect 35, wherein the validity duration is based at least in part on a confidence associated with one or more predicted measurements of the one or more channel characteristics.
Aspect 41: A UE for wireless communications, comprising one or more memories storing processor-executable code, and one or more processors coupled with the one or more memories and individually or collectively operable to execute the code to cause the UE to perform a method of any of aspects 1 through 14.
Aspect 42: A UE for wireless communications, comprising at least one means for performing a method of any of aspects 1 through 14.
Aspect 43: A non-transitory computer-readable medium storing code for wireless communications, the code comprising instructions executable by one or more processors to perform a method of any of aspects 1 through 14.
Aspect 44: A UE for wireless communications, comprising one or more memories storing processor-executable code, and one or more processors coupled with the one or more memories and individually or collectively operable to execute the code to cause the UE to perform a method of any of aspects 15 through 22.
Aspect 45: A UE for wireless communications, comprising at least one means for performing a method of any of aspects 15 through 22.
Aspect 46: A non-transitory computer-readable medium storing code for wireless communications, the code comprising instructions executable by one or more processors to perform a method of any of aspects 15 through 22.
Aspect 47: A network entity for wireless communications, comprising one or more memories storing processor-executable code, and one or more processors coupled with the one or more memories and individually or collectively operable to execute the code to cause the network entity to perform a method of any of aspects 23 through 34.
Aspect 48: A network entity for wireless communications, comprising at least one means for performing a method of any of aspects 23 through 34.
Aspect 49: A non-transitory computer-readable medium storing code for wireless communications, the code comprising instructions executable by one or more processors to perform a method of any of aspects 23 through 34.
Aspect 50: A network entity for wireless communications, comprising one or more memories storing processor-executable code, and one or more processors coupled with the one or more memories and individually or collectively operable to execute the code to cause the network entity to perform a method of any of aspects 35 through 40.
Aspect 51: A network entity for wireless communications, comprising at least one means for performing a method of any of aspects 35 through 40.
Aspect 52: A non-transitory computer-readable medium storing code for wireless communications, the code comprising instructions executable by one or more processors to perform a method of any of aspects 35 through 40.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, a first control signal that indicates one or more channel measurement resources;
measure one or more channel characteristics associated with the one or more channel measurement resources to obtain one or more measurements of the one or more channel characteristics; and
transmit, to the network entity, a channel state information report, wherein the channel state information report comprises, based at least in part on a Doppler frequency associated with the one or more channel measurement resources, the one or more measurements of the one or more channel characteristics or one or more predicted measurements of the one or more channel characteristics; wherein the one or more predicted measurements of the one or more channel characteristics are based at least in part on the one or more measurements of the one or more channel characteristics.

2. The UE of claim 1, wherein, to transmit the channel state information report, the one or more processors are individually or collectively operable to execute the code to cause the UE to:
include, in the channel state information report, the one or more measurements of the one or more channel characteristics or the one or more predicted measurements of the one or more channel characteristics based at least in part on a comparison of the Doppler frequency with a threshold, wherein the one or more measurements of the one or more channel characteristics are included in the channel state information report when the Doppler frequency is less than the threshold, and wherein the one or more predicted measurements of the one or more channel characteristics are included in the channel state information report when the Doppler frequency is greater than the threshold.

3. The UE of claim 2, wherein the one or more processors are individually or collectively further operable to execute the code to cause the UE to:
receive, from the network entity prior to transmission of the channel state information report, the threshold associated with the Doppler frequency.

4. The UE of claim 2, wherein the threshold is associated with a frequency band.

5. The UE of claim 1, wherein, to transmit the channel state information report, the one or more processors are individually or collectively operable to execute the code to cause the UE to:
include, in the channel state information report, the one or more measurements of the one or more channel characteristics or the one or more predicted measurements of the one or more channel characteristics based at least in part on a prediction window associated with the channel state information report and a channel coherency time associated with the Doppler frequency; wherein the prediction window is based at least in part on a report time at which the channel state information report is to be transmitted.

6. The UE of claim 5, wherein, to include, in the channel state information report, the one or more measurements of the one or more channel characteristics or the one or more predicted measurements of the one or more channel characteristics, the one or more processors are individually or collectively operable to execute the code to cause the UE to:
include the one or more measurements of the one or more channel characteristics in the channel state information report based at least in part on the report time being less than the channel coherency time or including the one or more predicted measurements of the one or more channel characteristics in the channel state information report based at least in part on the report time being greater than the channel coherency time.

7. The UE of claim 1, wherein the one or more processors are individually or collectively further operable to execute the code to cause the UE to:
generate the one or more predicted measurements of the one or more channel characteristics based at least in part on the Doppler frequency.

8. The UE of claim 1, wherein the one or more processors are individually or collectively further operable to execute the code to cause the UE to:
generate the one or more predicted measurements of the one or more channel characteristics based at least in part on the Doppler frequency and a prediction window, wherein the prediction window is based at least in part on a report time at which the channel state information report is to be transmitted.

9. The UE of claim 1, wherein the one or more processors are individually or collectively further operable to execute the code to cause the UE to:
transmit, to the network entity, a Doppler report that indicates the Doppler frequency associated with the one or more channel measurement resources; and
receive, from the network entity based at least in part on the Doppler report, a second control signal that indicates a configuration associated with the channel state information report, wherein the configuration indicates that the channel state information report comprises the one or more channel measurement resources or the one or more predicted measurements of the one or more channel characteristics.

10. The UE of claim 1, wherein the one or more processors are individually or collectively further operable to execute the code to cause the UE to:
receive, from the network entity prior to transmitting the channel state information report, a second control signal that indicates a configuration associated with the channel state information report, wherein the configuration indicates that the channel state information report comprises the one or more channel measurement resources or the one or more predicted measurements of the one or more channel characteristics based at least in part on the Doppler frequency.

11. The UE of claim 1, wherein the one or more predicted measurements of the one or more channel characteristics are associated with a group of resources based at least in part on the Doppler frequency.

12. The UE of claim 1, wherein the one or more processors are individually or collectively further operable to execute the code to cause the UE to:
transmit, to the network entity, a second control signal that indicates a prediction recommendation based at least in part on the Doppler frequency and computational resources of the UE, wherein the prediction recommendation indicates whether the UE recommends a determination of predicted measurements of the one or more channel characteristics associate with future resources.

13. A user equipment (UE), comprising:
one or more memories storing processor-executable code; and
one or more processors coupled with the one or more memories and individually or collectively operable to execute the code to cause the UE to:
receive, from a network entity, a first control signal that indicates one or more channel measurement resources;
measure one or more channel characteristics associated with the one or more channel measurement resources to obtain one or more measurements of the one or more channel characteristics; and
transmit, to the network entity, a channel state information report, wherein the channel state information report comprises one or more channel characteristics and a validity duration associated with the one or more channel characteristics, wherein the validity duration is based at least in part on a Doppler frequency associated with the one or more channel measurement resources, wherein the one or more channel characteristics are based at least in part on the one or more measurements of the one or more channel characteristics.

14. The UE of claim 13, wherein the one or more processors are individually or collectively further operable to execute the code to cause the UE to:
receive, from the network entity prior to transmitting the channel state information report, a second control signal that indicates a configuration associated with the channel state information report, wherein the configuration indicates that the channel state information report comprises the validity duration.

15. The UE of claim 13, wherein the one or more processors are individually or collectively further operable to execute the code to cause the UE to:
generate one or more predicted measurements of the one or more channel characteristics based at least in part on the one or more measurements of the one or more channel characteristics, wherein the one or more channel characteristics are based at least in part on the one or more predicted measurements of the one or more channel characteristics.

16. The UE of claim 15, wherein the validity duration indicates a start time and an end time associated with the one or more predicted measurements of the one or more channel characteristics.

17. The UE of claim 13, wherein the one or more processors are individually or collectively further operable to execute the code to cause the UE to:
receive, from the network entity based at least on the validity duration, a second control signal that indicates a channel state information prediction periodicity.

18. The UE of claim 13, wherein the one or more processors are individually or collectively further operable to execute the code to cause the UE to:
receive, from the network entity based at least on the validity duration, a second control signal that indicates a reference signal periodicity.

19. The UE of claim 13, wherein the validity duration is based at least in part on a confidence associated with one or more predicted measurements of the one or more channel characteristics.

20. A method for wireless communications by a user equipment (UE), comprising:
receiving, from a network entity, a first control signal that indicates one or more channel measurement resources;
measuring one or more channel characteristics associated with the one or more channel measurement resources to obtain one or more measurements of the one or more channel characteristics; and
transmitting, to the network entity, a channel state information report, wherein the channel state information report comprises, based at least in part on a Doppler frequency associated with the one or more channel measurement resources, the one or more measurements of the one or more channel characteristics or one or more predicted measurements of the one or more channel characteristics; wherein the one or more predicted measurements of the one or more channel characteristics are based at least in part on the one or more measurements of the one or more channel characteristics.
